(19) United States
(12) Patent Application Publication
(10) Pub. No.: US 2012/0110510 A1
(43) Pub. Date: May 3, 2012

(54) ELECTRONIC DEVICE AND METHOD FOR ADJUSTING SETTINGS THEREOF

(76) Inventors: Liew Hui Min Cindy, Taipei (TW); Ng Wan Lynn, Taipei (TW); Lionel Wong Zhen Jie, Taipei (TW); Chen Hung-Hsiang, Taipei (TW); Daniel Pittella Alenquer, Taipei (TW); Loi Wean Fong, Taipei (TW); Alec Wong, Taipei (TW); Shih Chia-Cheng, Taipei (TW); Lee Yun Qin, Taipei (TW)

(21) Appl. No.: 12/938,675

(22) Filed: Nov. 3, 2010

(51) Int. Cl. G06F 3/048

(52) U.S. Cl. 715/833

(57) ABSTRACT

A method for adjusting settings of an electronic device is disclosed. The method includes the steps as follows: providing a user interface including a plurality of main setting menu keys and a control unit; selecting one of the main setting menu keys to call a main setting value corresponding to the main setting menu key; outputting a corresponding main setting option image at least including a main setting value display area according to the main setting value; and providing a touch control event to operate the control unit for adjusting the main setting value and then display the adjusted main setting value on the main setting value display area. The touch control event includes a touch displacement event and a touch event. The method for adjusting the settings is contemplated for user's intuitive operation to save the time cost.

### BACKGROUND OF THE INVENTION

1. Field of Invention

The invention relates to an electronic device and a method for adjusting settings thereof and, more particularly, to an electronic device suitable for intuitive operation and the method for adjusting the settings thereof.

2. Related Art

With the progress of science and technology, people would like to use an electronic device instead of papers to output images. The electronic device becomes to be the most common operation and communicating media. Since the objectives of usage are different, and the image content varies, an electronic device usually includes a controlling interface to allow the user to adjust the settings, thereby making the outputted image clear and suitable for watching for a long time.

FIG. 1 is a schematic diagram showing a conventional projector. FIG. 2A is a control interface of the projector in FIG. 1. FIG. 2B is a schematic diagram showing that the settings of the projector are adjusted. As shown in FIG. 1, a projector 1 includes a control interface 11, a processing unit 12 and an image output unit 13. The control interface 11 includes a menu key 111, an input key 112, a return key 113 and a direction key 114 (as shown in FIG. 2A). After pressing the menu key 111, the user may press the direction key 114 and look for the option which needs to be adjusted in the displayed image. Then a signal is input to the processing unit 12 to call the setting value of the option to be adjusted or set again. Therefore, the objective of changing the projected image of the image output unit 13 is achieved.

As shown in FIG. 2B, during the adjusting process, the image output unit 13 outputs the adjusting image to allow the user to watch. However, obviously, when the control interface 11 is operated, the user has to look for the option which needs to be adjusted line by line, which is inconvenient in controlling. Sometimes, the adjusted image is small, and the user may wrongly watch or select the option, and he may not finish the adjustment quickly, which is an unpleasant experience to the user using the projector frequently.

Therefore, a new electronic device and the method for adjusting the settings thereof are designed, by improving or integrating the software or hardware, the user may directly and intuitively adjust the image, which saves labor, time and cost, and increases competitiveness and efficient.

### SUMMARY OF THE INVENTION

The invention discloses an electronic device and a method for adjusting settings thereof. By improving or integrating software or hardware, the user may directly and intuitively adjust the image, which saves labor, time and cost, and increases competitiveness and efficient.

The method for adjusting the settings of the electronic device includes the steps as follows: providing a user interface with multiple main setting menu keys and a control unit; selecting one of the main setting menu keys to call a main setting value corresponding to the main setting menu key; outputting a corresponding main setting option image according to the main setting value, and the main setting option image at least includes a main setting value display area; and providing a touch displacement event to operate the control unit to adjust the main setting value. The touch displacement event is achieved by moving relative to the first touching position by continuously touching the control unit after first touching the control unit, thereby adjusting the main setting value. In addition, the main setting value display area displays the adjustment of the main setting value corresponding to the touch displacement event.

An electronic device according to the invention includes a user interface, a processing unit and an image output unit.

The user interface includes multiple main setting menu keys and a control unit. The processing unit is connected to the user interface, receiving the signal provided from one of the main setting menu keys and calling a main setting value corresponding to the main setting menu key.

The image output unit is connected to the processing unit, and the processing unit drives the image output unit to output a main setting option image corresponding to the main setting value according to the main setting value. The main setting option image at least includes a main setting value display area;

The control unit receives a touch displacement event to adjust the main setting value. The touch displacement event is achieved by moving relative to the first touching position by continuously touching the control unit after first touching the control unit, thereby adjusting the main setting value, and the main setting value display area displays the adjustment of the main setting value corresponding to the touch displacement event.

Therefore, in the electronic device of the invention and the method for adjusting the settings thereof, multiple main setting menu keys are disposed on the user interface, and the user may intuitively select the frequently-used options and finish the adjustment quickly. This not only saves time, but also reduces the trouble in looking for the key one after another after a single menu key is pressed.

In addition, the user interface in the invention may also include a control unit which may be operated in a pressing or sliding mode to replace the conventional cross directional key. The control unit cooperates with a graphical user interface and main setting menu keys to make the adjustment smoother, and the user also may adjust the images at his will. The electronic device and the method for adjusting the settings thereof include a human-friendly control interface, and comparing with the conventional electronic device, the invention is more intuitive.

When the invention is used in a projector, since the projected screen, the distance, the image content, the size and so on are not fixed, it is a necessary step to set the projector before the projector is used. The technique in the invention may help the user to finish the adjustment quickly and correctly, and therefore the user may not feel troublesome in using the projector.

### BRIEF DESCRIPTION OF THE DRAWINGS

FIG. 1 is a schematic diagram showing a conventional projector;

FIG. 2A and FIG. 2B are schematic diagrams showing that the projector in FIG. 1 is set;

FIG. 3 is a schematic diagram showing the electronic device in the first embodiment of the invention;

FIG. 4 is an enlarged diagram showing the user interface of the electronic device in FIG. 3;

FIG. 5A is a schematic diagram showing the movement that the user selects the main setting menu key to call the corresponding main setting value;

FIG. 5B is a schematic diagram showing the displayed main setting option image corresponding to the movement in FIG. 5A;

FIG. 6A is a schematic diagram showing the movement that the user operates the control unit to adjust the main setting value;

FIG. 6B is a schematic diagram showing the displayed main setting option image corresponding to the movement in FIG. 6A;

FIG. 7A and FIG. 7B are schematic diagrams showing that the user operates the control unit in the first embodiment in different sliding modes to adjust the main setting value;

FIG. 8A is a schematic diagram showing the movement that the user selects the sub-setting menu key to call the sub-setting menu image;

FIG. 8B is a schematic diagram showing the displayed sub-setting menu image corresponding to the movement in FIG. 8A;

FIG. 9A is a schematic diagram showing the movement of selecting the sub-setting option in the sub-setting menu when the user operates the control unit;

FIG. 9B is a schematic diagram showing the displayed sub-setting menu image corresponding to the movement of FIG. 9A;

FIG. 10 is an enlarged schematic diagram showing the user interface of the electronic device in the second embodiment of the invention;

FIG. 11A is a schematic diagram showing the movement that the user operates the control unit to adjust the main setting value in the second embodiment of the invention;

FIG. 11B and FIG. 11C are schematic diagrams showing the displayed main setting option image corresponding to the movement in FIG. 11A;

FIG. 12 is a schematic diagram showing that the sub-selecting menu is displayed on the image in the second embodiment of the invention;

FIG. 13A and FIG. 13B are schematic diagrams showing that the user operates the control unit in the second embodiment of the invention in different sliding modes to adjust the main setting value;

FIG. 14A is an enlarged schematic diagram showing the user interface of the electronic device in the third embodiment of the invention;

FIG. 14B is a schematic diagram showing the displayed main setting option image corresponding to the movement in FIG. 14A;

FIG. 15 is a schematic diagram showing that the sub-setting menu in the third embodiment of the invention is displayed on the image;

FIG. 16 is a flow chart showing the method for adjusting the settings of the electronic device in the first embodiment of the invention; and

FIG. 17 is a flow chart showing the method for adjusting the settings of the electronic device in the second embodiment of the invention.

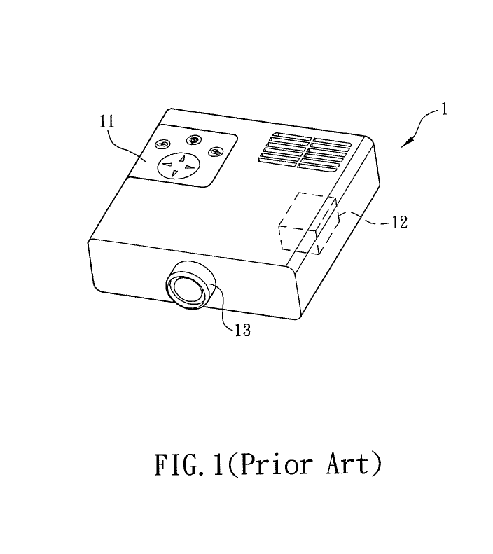

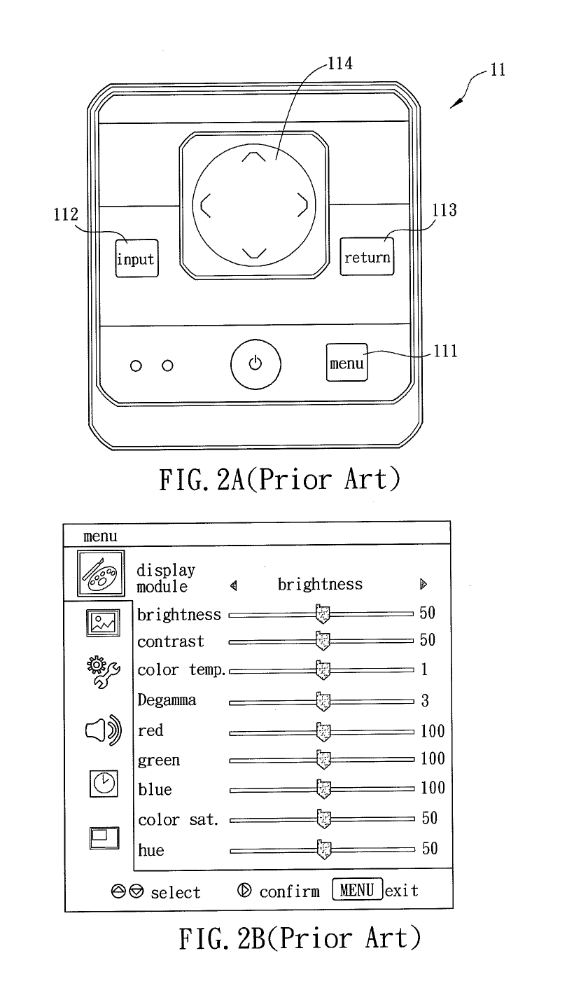

### DETAILED DESCRIPTION OF THE INVENTION

These and other features, aspects and advantages of the electronic device of the invention and the method for adjusting the settings thereof will become better understood with regard to the following description, appended claims, and accompanying drawings. In the embodiments, the same symbols denote the same elements.

The electronic device in the invention can be used in electronic devices such as a projector, a desktop computer screen or a notebook computer screen. In the following embodiments the projector is used as an example. However, the technique disclosed in the invention also may be adapted to any other electronic devices with image output function and adjustable settings, and the projector is just an example.

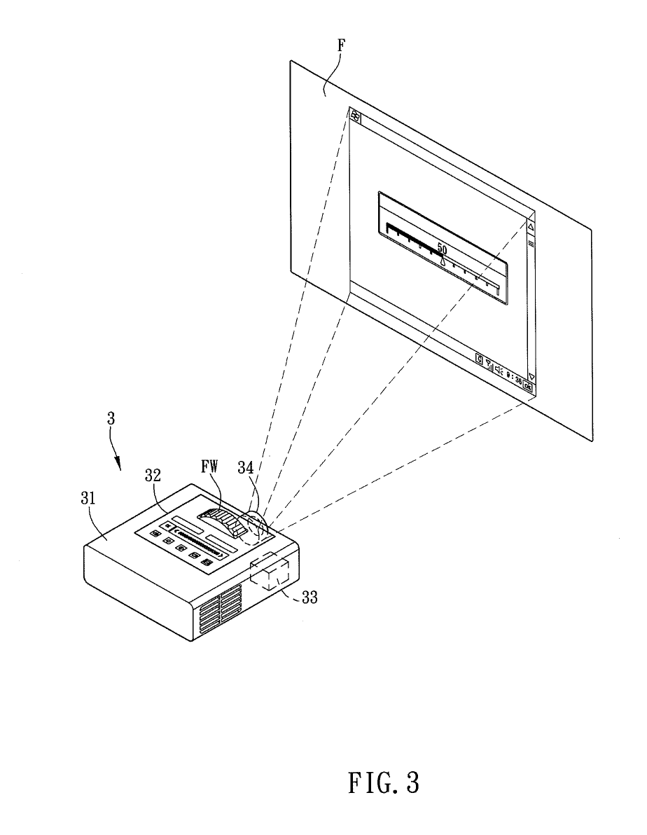

FIG. 3 is a schematic diagram showing the electronic device in the first embodiment of the invention. As shown in FIG. 3, the electronic device 3 includes a casing 31, a user interface 32, a processing unit 33 and an image output unit 34.

The user interface 32 is disposed on a casing 31, and it may be disposed on the electronic device 3. The processing unit 33 is disposed in the casing 31 and connected to the user interface 32. The processing unit 33 processes the signal input from the user interface 32, and performs the corresponding controlling function. In addition, the image output unit 34 may be disposed at the front of the electronic device 3 for outputting an image F. However, in other embodiments of the invention, the user interface 32 also may be connected to the electronic device 3 in a wireless transmission mode, and it may not be disposed at the casing 31.

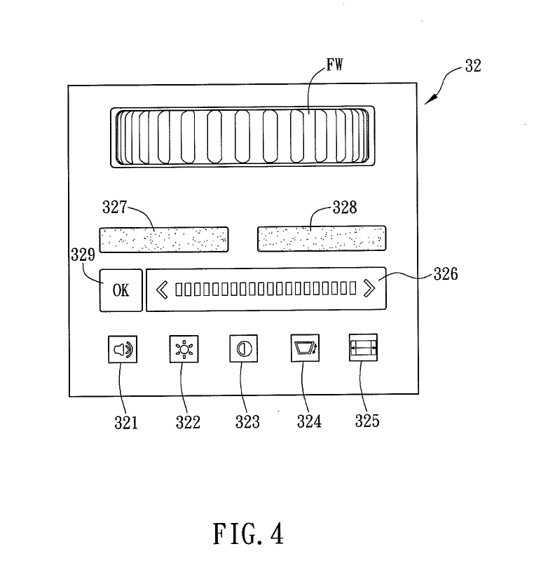

FIG. 4 is an enlarged diagram showing the user interface of the electronic device in FIG. 3. As shown in FIG. 4, the user interface 32 includes multiple main setting menu keys 321 to 325 and a control unit 326. The user interface 32 may be a capacitive touch panel, a resistive touch panel or a physical keyboard, which is not limited thereto.

In the embodiment, the user interface 32 may be a capacitive touch panel, the main setting menu keys 321 to 325 are multiple virtual keys defined in the touch panel by programs, and the control unit 326 may be a touch scroll. In addition, a light emitting diode (LED) module may be disposed below the user interface 32, and when the user operates, the LED emits light to allow the user to identify the virtual key or the touch scroll when the user operates the user interface.

The user may operate the user interface 32 to input a signal to the electronic device 3 via the main setting menu keys 321 to 325 and the control unit 326. The main setting menu key 321 to 325 may be different common main setting menu keys including volume, brightness, contrast, key tone and aspect ratio options. In the embodiment, the main setting menu key 321 represents a volume setting option, the main setting menu key 322 represents a brightness setting option, the main setting menu key 323 represents a contrast ration setting option, the main setting menu key 324 represents a key tone setting option, and the main setting menu key 325 represents an aspect ratio setting option. In addition, in the embodiment, although the focus adjusting wheel FW is achieved in a common rotating scroll mode, it also may be an option key, which is not limited in the invention.

The user selects one of the corresponding main setting menu keys 321 to 325 according to the option which needs to be adjusted, and then a selecting signal is outputted to the processing unit 33. In the embodiment, the selecting way may be achieved by pressing, clicking or touching to enable the function of one of the main setting menu keys 321 to 325. The movement of selecting may be different along with different user interfaces 32, and the selected main setting menu keys 321 to 325 may not be limited to only one. For example, the user may touch two main setting menu keys 321 and 322 at the same time to adjust two options, and the invention is not limited thereto.

Since the processing unit 33 is connected to the user interface 32, when one of the main setting menu keys 321 to 325 is selected, the processing unit 33 receives the signal provided by the main setting menu key. Then, the processing unit 33 calls a main setting value stored in a storage unit (not shown) corresponding to the signal, thereby making the main setting value adjustable.

After the main setting value is obtained, the processing unit 33 outputs a corresponding main setting option image according to the main setting value. The main setting option image at least includes a main setting value display area for displaying the status of the main setting value and the graphics area for showing the change of the main setting value. Afterwards, according to another signal generated when the user operates the control unit 326, the processing unit 33 executes the corresponding calculating function to adjust the main setting value.

The adjustment of the setting value may be shown via a value change, a bar chart increment or decrement, a contrast image before and after adjustment and/or their combinations, and it is displayed in the main setting main setting value display area. The value change is that the adjusted magnitude is represented by increasing or decreasing value. The bar chart increment or decrement is achieved by taking an end of the bar as a start point, increasing or decreasing the length of the bar from the end to the other end corresponding to the adjusted magnitude of the main setting value. The bar chart in the invention also may take a midpoint as a center, and extending from the center to the two ends and retracting to the center represent the main setting value increment or decrement, respectively. In addition, the contrast of the images before and after adjustment may be achieved by dividing the image into a left part and a right part, the left part displays the image before adjusted, and the right part displays the image after adjusted, they are contrasted with each other to allow the user to refer.

The feature of the display device 3 in the invention will be illustrated with regard to the above embodiment cooperating with a practical operation.

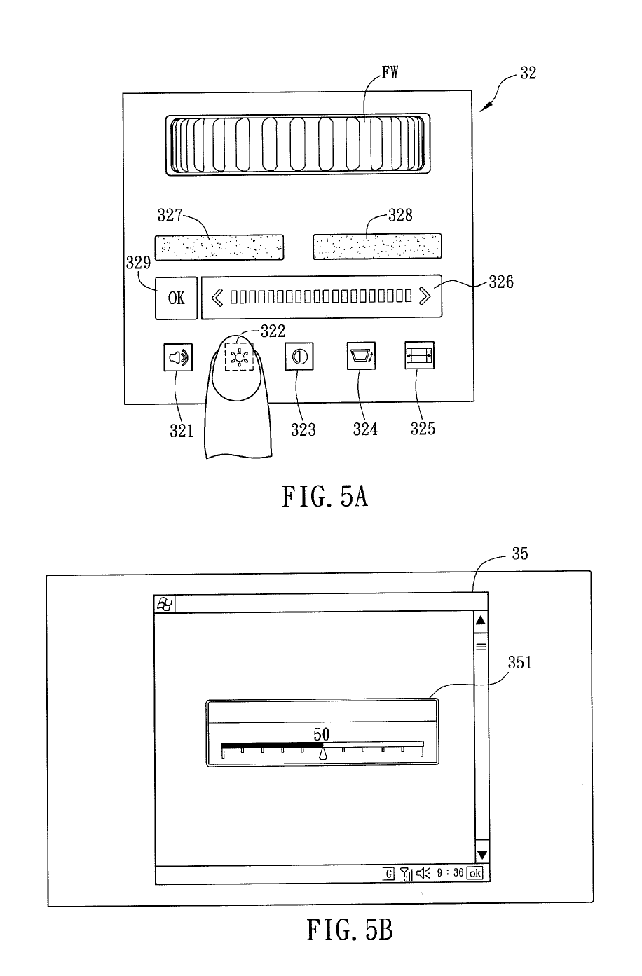

FIG. 5A is a schematic diagram showing the movement that the user selects the main setting menu key to call the corresponding main setting value, and FIG. 5B is a schematic diagram showing the displayed main setting option image corresponding to the movement in FIG. 5A. As shown in FIG. 5A and FIG. 5B, when the user would like to adjust the brightness of the image outputted from the electronic device 3, he may touch the main setting menu key 322. After the main setting menu key 322 is enabled, and the signal is outputted to the processing unit 33, the processing unit 33 calls and obtains the corresponding setting value of the brightness.

Afterwards, the processing unit 33 outputs a corresponding main setting option image 35 according to the setting value, and the main setting option image 35 at least includes the main setting value display area 351 displayed via a bar chart. In the embodiment, the shape of the main setting value display area 351 corresponds to that of the control unit 326 to make the operation of the user to the control unit directly reflected on the main setting value display area 351.

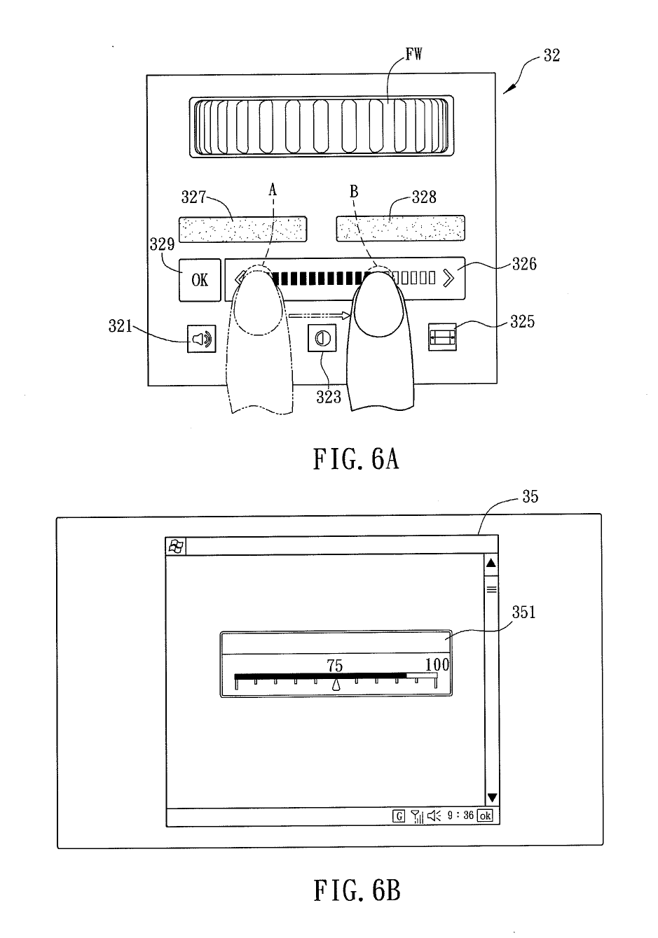

FIG. 6A is a schematic diagram showing the movement that the user operates the control unit to adjust the main setting value. FIG. 6B is a schematic diagram showing the displayed main setting option image corresponding to the movement in FIG. 6A. As shown in FIG. 6A, the user provides a touch displacement event to operate the control unit 326, and thus the main setting value is adjusted to adjust the brightness of the image.

The touch displacement event may be achieved by moving the finger to position B from position A by continuously touching the control unit 326 after the user touches first the control unit 326, thereby generating the corresponding signal according to the change of the position and driving the processing unit 33 to adjust the main setting value. In Detailed, the touch displacement event may be but not limited to be sliding, and the sliding way is single point single direction sliding.

Therefore, when the user generates a touch displacement event in the control unit (sliding from position A to position B on the control unit 326), and the displayed main setting value (brightness) in the main setting value display area 351 increases (comparing with that in FIG. 5B and FIG. 6B) corresponds to the touch displacement event, and the image outputted by the electronic device 3 is brighter.

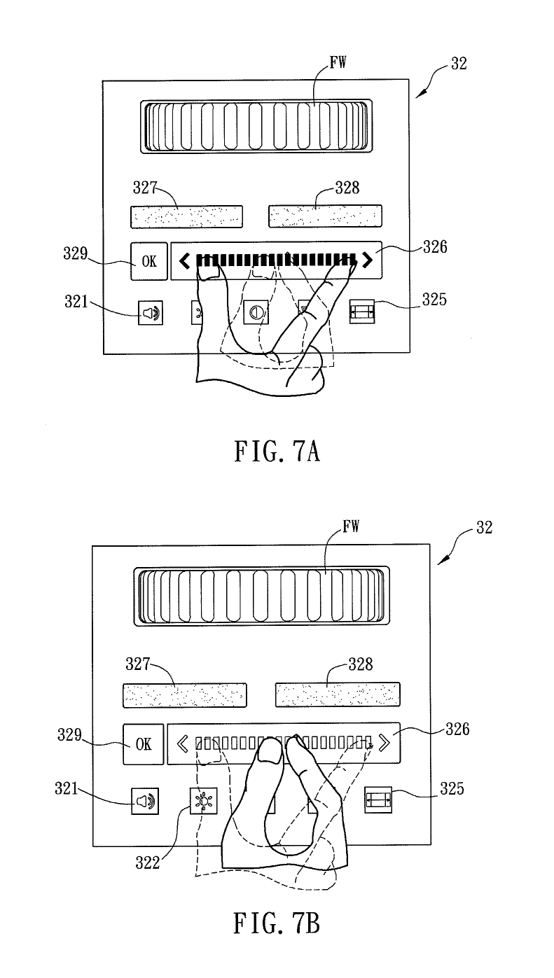

Besides the single point single direction sliding, the invention also may include other sliding ways cooperating with the above control unit 326, which includes the multi-points radial sliding (as shown in FIG. 7A) and the multi-points retractive sliding (as shown in FIG. 7B). The former may be achieved by moving two fingers outwardly, respectively, and the latter may be moving two fingers inwardly, respectively, and the invention is not limited thereto. However, the sliding ways may be combined with each other to represent different functions or different adjusting ways, and the invention is not limited thereto.

Therefore, as disclosed in the electronic device of the invention, via multiple main setting keys and the control unit, the user may intuitively select the option which needs to be adjusted, and then the invention allows the user to use human-based control gestures to adjust the setting of the electronic device. This improves the convenience compared with the conventional technology, and also saves the time.

As shown in FIG. 3, in the embodiment of the invention, the user interface 32 further includes sub-setting menu keys 327 and 328. The structures of the sub-setting menu keys 327 and 328 are the same as those of the main setting menu keys 321 to 325, and they are not illustrated again for a concise purpose.

The sub-setting menu keys 327 and 328 represent different sub-function menus. The sub-function menu herein is a defined list, which lists the group including setting options which are rarely used during adjusting the electronic device 3. The sub-setting options may include keystone, projecting modes (such as front projection, front hanging projection, reverse side projection and reverse side hanging projection), horizontal position, vertical position, frequency, phase, signal input, definition, white balance, time setting, status information and so on.

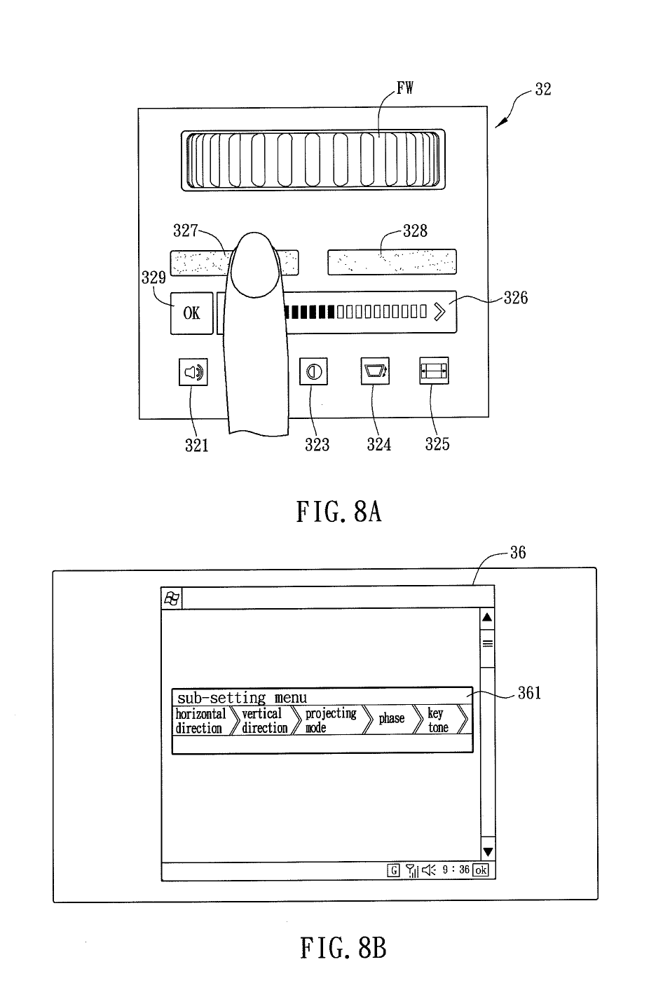

FIG. 8A is a schematic diagram showing the movement that the user selects the sub-setting menu key to call the sub-setting menu image. FIG. 8B is a schematic diagram showing the displayed sub-setting menu image corresponding to the movement of FIG. 8A. As shown in FIG. 8A, in the embodiment, when the user would like to adjust the sub-setting options, he touches the sub-setting menu key 327 or 328 of the user interface 32 to provide a signal to the processing unit 33, thereby calling and generating the sub-setting menu image 36 corresponding to the sub-setting menu key, and then the image output unit 34 outputs the sub-setting menu image 36 on the image (as shown in FIG. 8B). The sub-setting menu image 36 includes multiple graphics interfaces with multiple sub-setting options.

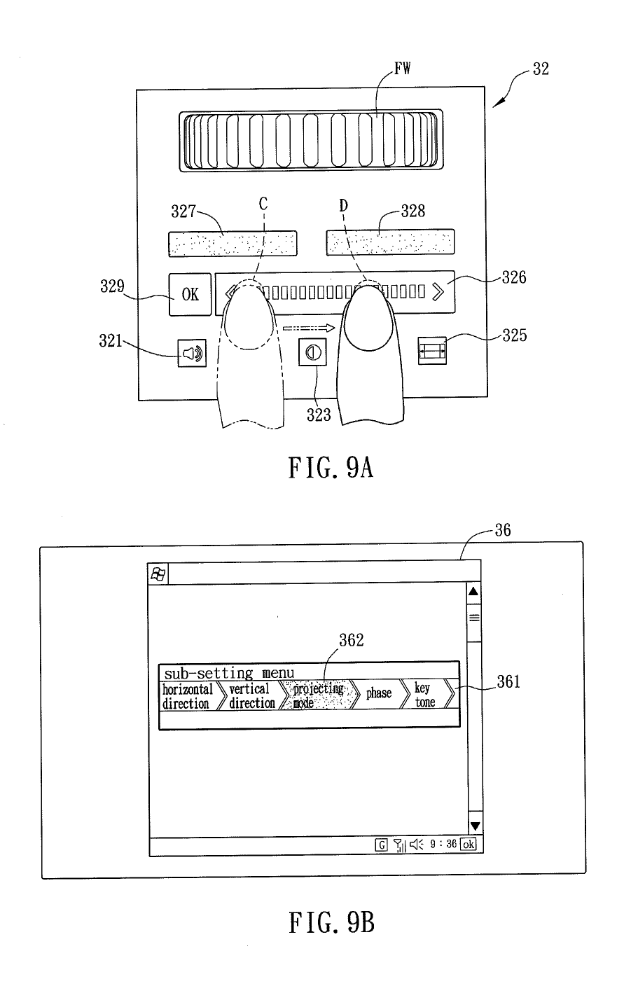

FIG. 9A is a schematic diagram showing the movement of selecting the sub-setting option when the user operates the control unit in the sub-setting menu. FIG. 9B is a schematic diagram showing the displayed sub-setting menu image corresponding to the movement of FIG. 9A.

As shown in FIG. 9A, in the embodiment, the user first touches the control unit 326 to provide a signal to the processing unit 33 and then drives the image output unit 34 to output and display a denoting mark on the sub-setting menu image 36. The denoting mark 362 may be a highlight area or a mark which fills one of the sub-setting options to make the sub-setting notable in the options.

The user generates the touch displacement event by generating the single point single direction sliding to operate the control unit (moving from position C to position D on the control unit 326), thereby moving the denoting mark 362 to multiple sub-setting options of the sub-setting menu image corresponding to the touch displacement event.

After the denoting mark 362 moves to the needed sub-setting option (such as the projecting mode PA in FIG. 9A), he may choose to start the setting option by pressing a confirming key 329 or staying and waiting to select and start the setting option. In the embodiment, the setting option is started by pressing the confirming key 329.

Therefore, the sub-setting option provides the signal to the processing unit 33 to call the corresponding sub-setting value, and then drives the image output unit 34 by the processing unit 33 according to the sub-setting value to output a corresponding sub-setting option image. The sub-setting option image includes at least a sub-setting value display area. It is emphasized that the sub-setting option image is different from the sub-setting menu image 36 above mentioned. The sub-setting menu image means the image of display after adjusting the sub-setting option.

Then, the user operates the same control unit 326 via the same touch displacement event to adjust the sub-setting value. In the sub-setting option image, the sub-setting value display area also displays the adjustment of the sub-setting value corresponding to the touch displacement event. The sub-setting value herein may be the value of the sub-setting option or the detailed settings in the sub-setting option for selecting. For example, the sub-setting values 1 to 10 represent the first setting, and the sub-setting value 20 to 30 represent the second setting.

The way for the processing unit 33 to call the corresponding sub-setting value and the way for the user to operate the control unit 326 to adjust the sub-setting value are the same as the illustration relating to the main setting menu key 322 in the above embodiments and it is not illustrated again herein for a concise purpose. However, the same touch displacement event herein does not mean that the touching positions, displacements or adjust values in the two touch displacement event are the same, but means that all the two touch displacement events are achieved by moving the finger relative to the first-touch position by continuously touching the control unit 326 after the user touches the touching the control unit 326.

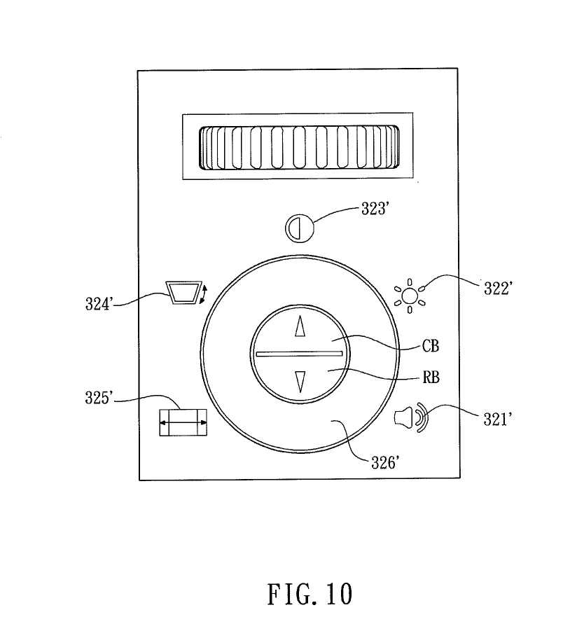

FIG. 10 is an enlarged schematic diagram showing the user interface of the electronic device in the second embodiment of the invention. As shown in FIG. 10, in the second embodiment, the electronic device herein is similar to the above electronic device, and the main setting menu keys 321′ to 325′ of the user interface 32′ are multiple virtual keys around the control unit 326′, and the control unit 326′ herein is a touch dial. In the following part, how the user uses the control unit 326′ to finish different adjustments is illustrated, and other details may be referred to the above embodiments.

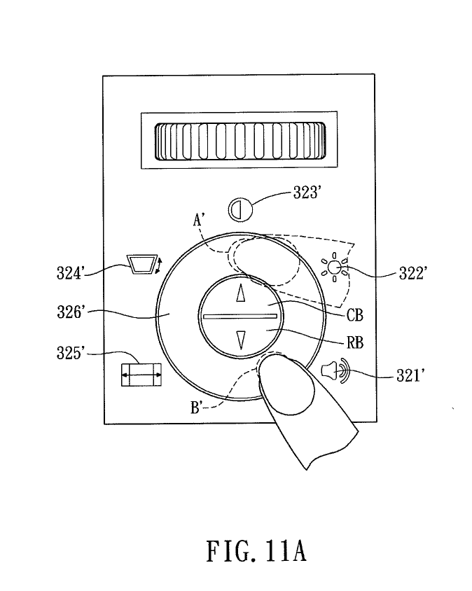

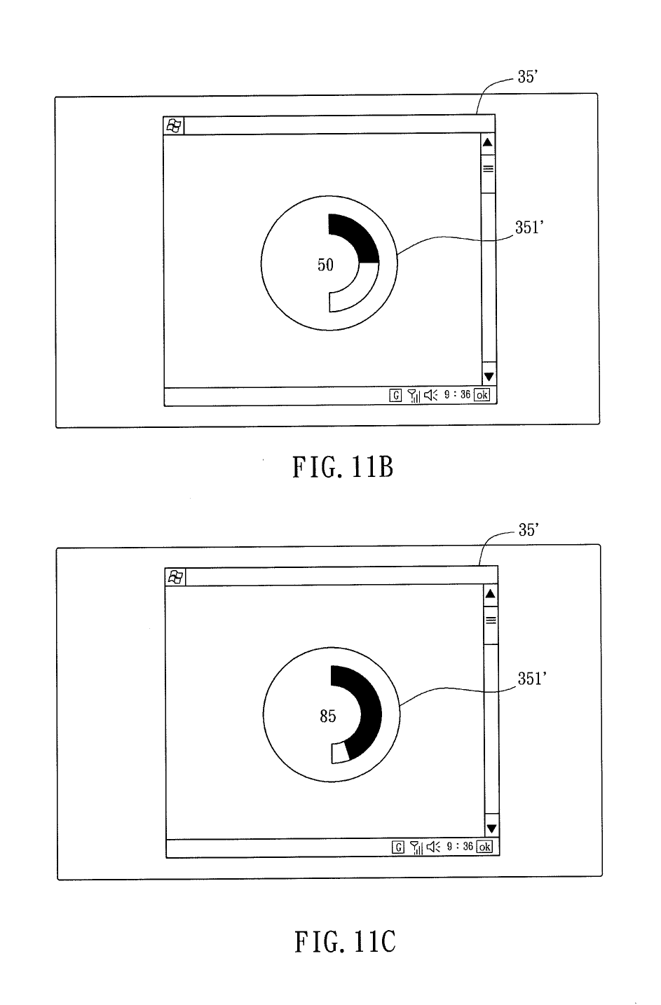

FIG. 11A is a schematic diagram showing the movement that the user operates the control unit to adjust the main setting value in the second embodiment of the invention. FIG. 11B and FIG. 11C are schematic diagrams showing the displayed main setting option image corresponding to the movement in FIG. 11A.

As shown in FIG. 11A, the user generates the touch displacement event to the control unit 326′ (the finger moves in curve lines on the control unit 326′) to adjust the main setting value, and the user's sliding operation is the single point clockwise sliding.

Therefore, when the user slides his finger from the position A′ to the position B′ on the control unit 326′, the displayed main setting value (brightness) in the main setting value display area 351′ of the main setting option image 35′ increases (comparing with that in FIG. 11B and FIG. 11C), and the image outputted by the electronic device is brighter. On the contrary, in the same main setting options, if the sliding operation is the single point anti-clockwise sliding, the value and brightness of the main setting value displayed in the main setting value display area 351′ decrease.

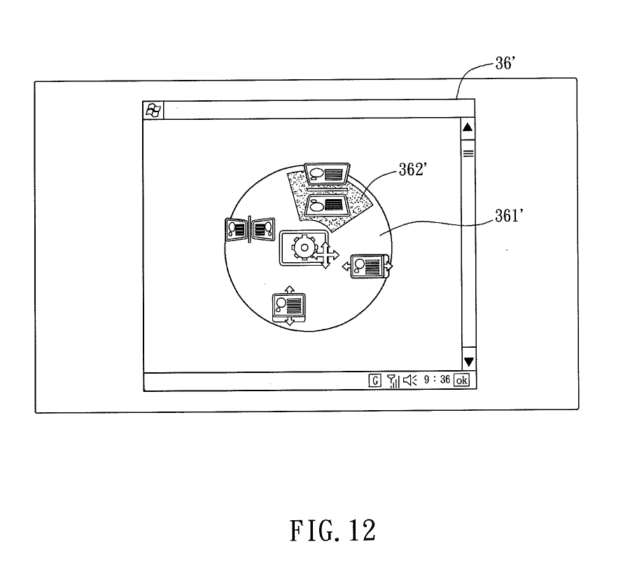

In addition, in the embodiment, when the user selects the sub-setting menu key, the graphics interface 361′ including the sub-selecting menu is displayed corresponding to the control unit 326′ (as shown in FIG. 12), and a denoting mark 362′ is displayed at the sub-setting menu image 36′ to allow the user to operate intuitively.

The user interface 32′ further includes the confirming key CB with the same function as that in the former embodiment. The return key RB allows the user to cancel the operation or go back to the original image.

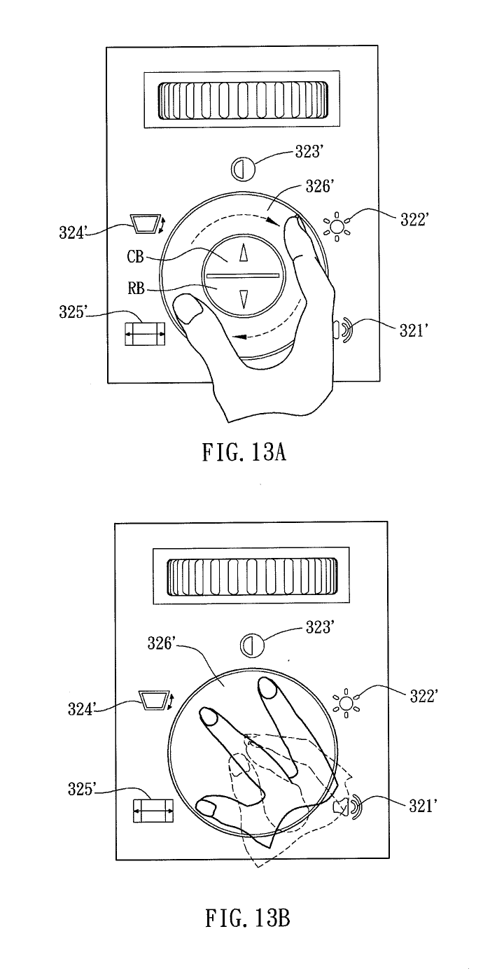

In addition, as shown in FIG. 13A and FIG. 13B, in other examples of the embodiment, different gestures may be used on the user interface 32′ and the control unit 326′ to generate the touch displacement event to adjust the setting value.

As shown in FIG. 13A, the user may use the multi-points rotating sliding mode (such as rotating with two points) to operate the control unit 326′, thereby increasing or decreasing the main setting value and the sub-setting value according to the clockwise or anti-clockwise direction.

As shown in FIG. 13B, the user also may operate the control unit 326′ in the multi-points radial sliding mode, and then the main setting value or the sub-setting value is adjusted according to the radial level or the speed. On the contrary, the user also may operate the control unit 326′ in the multi-point retractive sliding mode However, similar to the above embodiment, the sliding operation mode also may be combined with each other to represent different executing functions or adjusting levels.

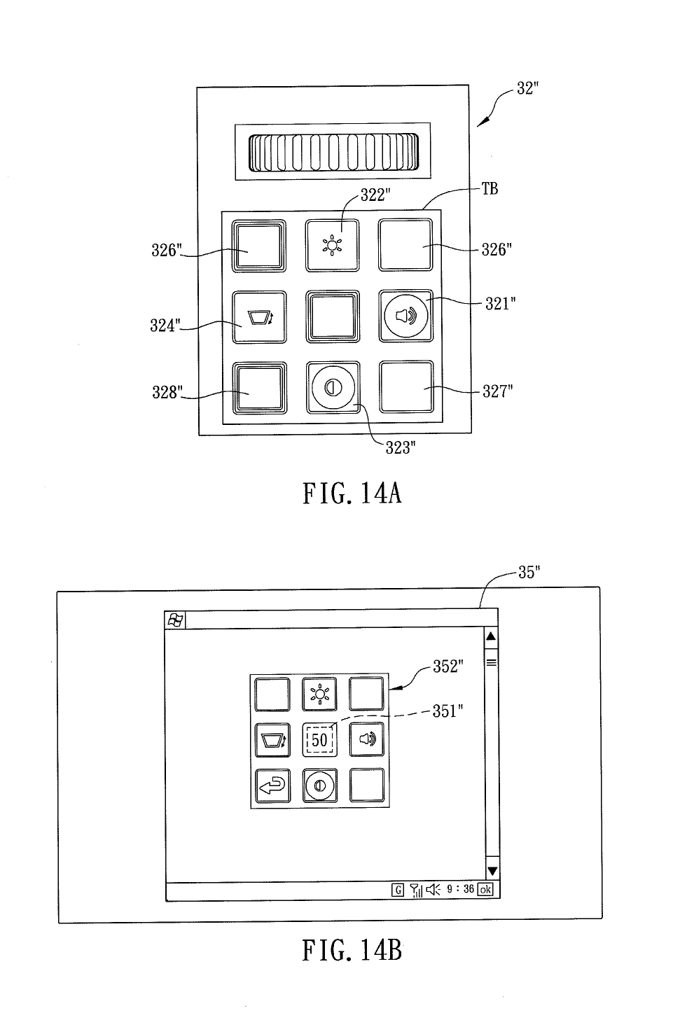

FIG. 14A is an enlarged schematic diagram showing the user interface of the electronic device in the third embodiment of the invention. As shown in FIG. 14A, in the third embodiment of the invention, the electronic device herein and the electronic device in the above embodiment are similar, and the difference is that the main setting menu keys 321″ to 324″ and the control unit 326″ in the user interface 32″ are nine-rectangle-grid touch keys TB. In another example of the embodiment, the main setting menu key 321″ to 324″ and the control unit 326″ also may be keys on the physical keyboard, and the invention is not limited thereto.

In addition, in the embodiment, the user operates the control unit 326″ by providing the touch event, which is a difference between the present embodiment and the former embodiments. In Detailed, the touch event is a press or at least one click on the control unit 326″ by the user with the finger, and the touch event can provide a signal to the processing unit every time to perform the corresponding functions.

No matter the touching mode is achieved by pressing or clicking, after the control unit 326″ is touched, the different touch time span may represent different input signals cooperating with software setting, and the invention is not limited thereto. In the embodiment, the touch event is achieved by pressing the control unit 326″ by the user, and the signal inputted to the processing unit is according to the number of the touch event, which is the number of pressing the control unit 326″, and the touch time span is not considered.

As shown in FIG. 14B, in the embodiment, the main setting option image 35″ at least includes a main setting value display area 351″ and a main setting graphical user interface 352″.

The main setting value display area 351″ is the same as that in the former embodiment, which is also displaying the main setting value corresponding to the operation of user (the touch event). However, the shape and configuration of the main setting graphical user interface 352″ correspond to those of the control unit 326″. In the embodiment, the main setting graphical user interface 352″ is also a nine-rectangle-grid form, and the key positions displayed on the main setting graphical user interface 352″ corresponds to those of the control unit 326″ to display multiple pieces of main setting value adjusting information to allow the user to have reference when generating the touch event.

For example, as shown in FIG. 14B, in the embodiment, in the three keys of the main setting graphical user interface 352″ corresponding to the upper three keys of the control unit 326″, the left key and right key displays decreasing the brightness and increasing the brightness, respectively. Consequently, the user generates the touch event on the control unit 326″ to finish the adjustment referring to the main setting graphical user interface 352″.

However, although the information displayed in the main setting graphical user interface 352″ corresponds to the function of the keys of the control unit 326″, the relation between the function of the keys and the positions of the control unit 326″ are not constant. They are determined by programs according to the selected main setting option or the selected sub-setting options.

For example, when the user would like to adjust the brightness and select the main setting menu key 322″ (which represents the brightness setting value), the processing unit of the electronic device defines the left key and the right key of the main setting menu key 322″ to be the control unit 326″ by programs. When the user presses the right key of the control unit 326″, the main setting value may increase, thereby increasing the output brightness of the image. On the contrary, when the user presses the left key of the control unit 326″, the main setting value may decrease, and the brightness of the output image is reduced. The position relation between one of the main setting menu key 321″ to 324″ and the control unit 326″ may be changed according to the programs, and the invention is not limited thereto.

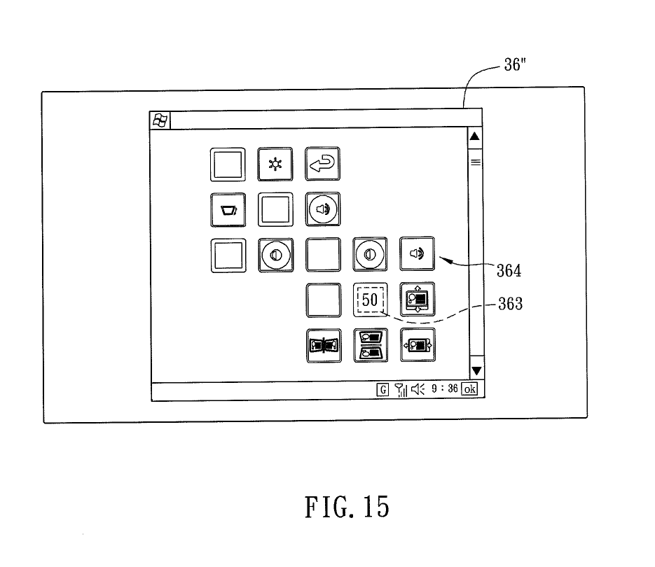

However, as shown in FIG. 14 and FIG. 15, in the embodiment, the sub-setting menu key 327″ and 328″ are also disposed at the touch key TB of the user interface 32″. When the user starts the sub-setting menu key 327″ and 328″, the processing unit outputs a corresponding sub-setting menu image 36″ according to the sub-setting value.

The sub-setting menu image 36″ at least includes a sub-setting value display area 363 and a sub-setting graphical user interface 364. The sub-setting value display area 363 and the sub-setting graphical user interface 364 are unfolded at the relative position of the touch key TB (as shown in FIG. 15), and via the programs, the control function of the touch key TB is converted to selection and/or controlling and the related sub-setting options in the sub-setting graphical user interface 364.

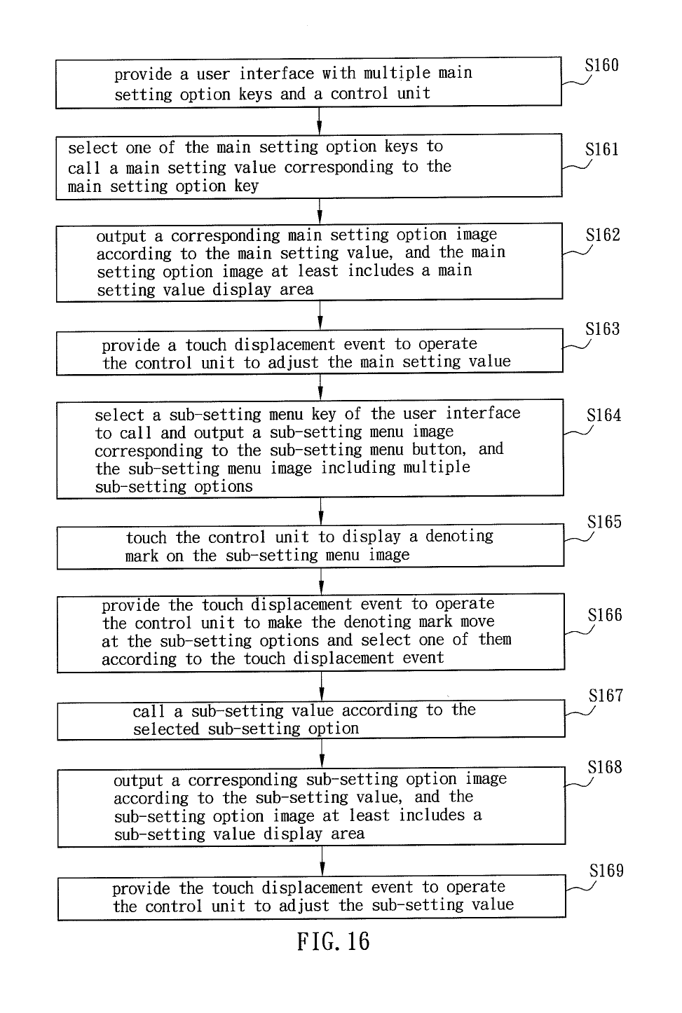

FIG. 16 is a flow chart showing the method for adjusting the settings of the electronic device in a preferred embodiment of the invention.

As shown in FIG. 16, in the embodiment, the method for adjusting the setting of the electronic device is adapted to the electronic device in the first and second embodiments of the invention to allow the user to adjust the outputted images, the method for settings includes the following steps.

In step S160, providing a user interface with multiple main setting menu keys and a control unit;

In step S161, selecting one of the main setting menu keys to call a main setting value corresponding to the main setting menu key;

In step S162, outputting a corresponding main setting option image according to the main setting value, and the main setting option image at least includes a main setting value display area; and

In step S163, providing a touch displacement event to operate the control unit and adjust the main setting value;

In step S164, selecting a sub-setting menu key of the user interface to call and output a sub-setting menu image corresponding to the sub-setting menu key, and the sub-setting menu image including multiple sub-setting options;

In step S165, touching the control unit to display a denoting mark on the sub-setting menu image;

In step S166, providing the touch displacement event to operate the control unit to make the denoting mark move between the sub-setting options and select one of them according to the touch displacement event.

In step S167, calling a sub-setting value according to the selected sub-setting option;

In step S168, outputting a corresponding sub-setting option image according to the sub-setting value, and the sub-setting option image at least includes a sub-setting value display area; and

In step S169, providing the touch displacement event to operate the control unit to adjust the sub-setting value.

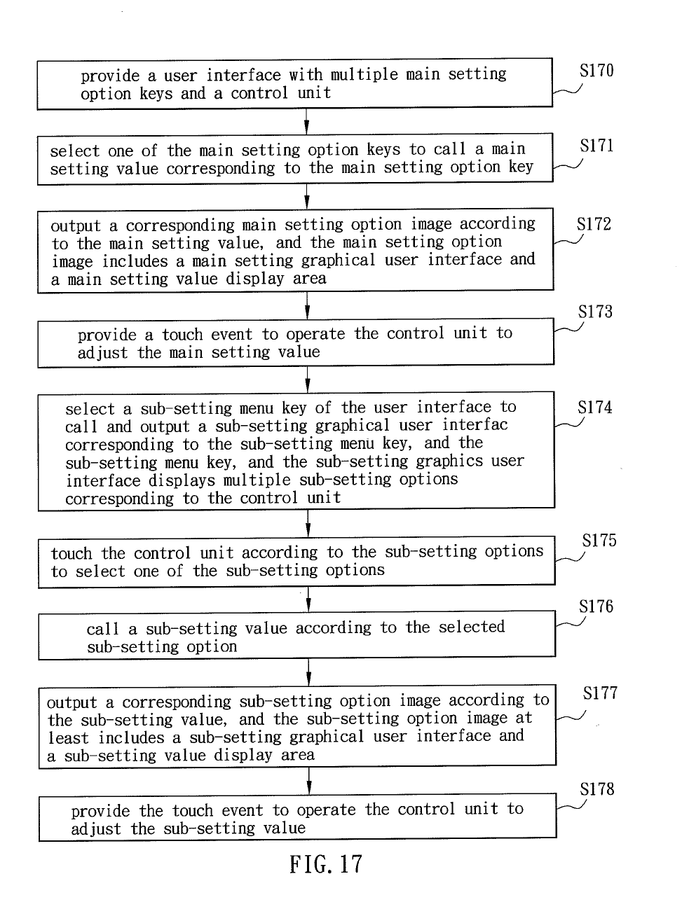

FIG. 17 is a flow chart showing the method for adjusting the settings of the electronic device in another embodiment of the invention. As shown in FIG. 17, in the embodiment, the method for adjusting the settings of the electronic device is adapted to the electronic device in the third embodiment of the invention to allow the user to adjust the outputted image. The adjusting method includes the following steps.

In step S170, providing a user interface with multiple main setting menu keys and a control unit;

In step S171, selecting one of the main setting menu keys to call a main setting value corresponding to the main setting menu key;

In step S172, outputting a corresponding main setting option image according to the main setting value, and the main setting option image includes a main setting graphical user interface and a main setting value display area;

In step S173, providing a touch event to operate the control unit and adjust the main setting value;

In step S174, selecting a sub-setting menu key of the user interface to call and output a sub-setting graphical user interface corresponding to the sub-setting menu key, and the sub-setting graphical user interface displays multiple sub-setting options corresponding to the control unit;

In step S175, touching the control unit according to the sub-setting options to select one of the sub-setting options;

In step S176, calling a sub-setting value according to the selected sub-setting option;

In step S177, outputting a corresponding sub-setting option image according to the sub-setting value, and the sub-setting option image at least includes a sub-setting graphical user interface and a sub-setting value display area; and

In step S178, providing the touch event to operate the control unit to adjust the sub-setting value.

To sum up, the invention discloses an electronic device and the method for adjusting the settings thereof. Via the main setting menu key disposed on the user interface, the user may intuitively select the options to finish the adjustment quickly. This not only saves time, but also reduces the inconvenience in finding the needed options line by line when a single menu key is used.

In addition, since the user interface in the invention can include the control unit operated by a pressing or sliding gesture to replace the conventional cross direction key. Cooperating with the graphical user interface and the main setting menu key, the user may use the electronic device smoother, and it may be more precise.

Comparing with the conventional image input device, the electronic device and the method for adjusting the settings in the invention include a human-friendly control interface, and comparing with the conventional electronic device, the invention is more intuitive. When the invention is used in a projector, since the projected screen, the distance, the image content, the size and so on are various, it is a necessary step to set the projector. The technique of the invention may help the user to finish the adjustment quickly and correctly, and therefore the user may not feel troublesome in using the projector.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for adjusting settings of an electronic device comprising the steps of:
providing a user interface with multiple main setting menu keys and a control unit;
selecting one of the main setting menu keys to call a main setting value corresponding to the main setting menu key;
outputting a corresponding main setting option image according to the main setting value, wherein the main setting option image includes a main setting value display area; and
providing a touch displacement event to operate the control unit and adjust the main setting value;
wherein the touch displacement event is achieved by moving relative to the first touching position by continuously touching the control unit after the first touching the control unit, thereby adjusting the main setting value, and the main setting value display area displays an adjustment of the main setting value corresponding to the touch displacement event.

2. The method for adjusting the settings according to claim 1, further comprising the steps of:
selecting a sub-setting menu key of the user interface to call and output a sub-setting menu image corresponding to the sub-setting menu key, wherein the sub-setting menu image includes multiple sub-setting options;
touching the control unit to display a denoting mark on the sub-setting menu image; and
providing the touch displacement event to operate the control unit to make the denoting mark move at the sub-setting options and select one of the sub-setting options according to the touch displacement event.

3. The method for adjusting the settings according to claim 2, further comprising the steps of:
calling a corresponding sub-setting value according to the selected sub-setting option;
outputting a corresponding sub-setting option image according to the sub-setting value, wherein the sub-setting option image at least includes a sub-setting value display area; and
providing the touch displacement event to operate the control unit to adjust the sub-setting value,
wherein the sub-setting value display area displays the adjustment of the sub-setting value corresponding to the touch displacement event.

4. The method for adjusting the settings according to claim 1, wherein the touch displacement event is achieved by sliding along a straight line or a curved line on the control unit.

5. The method for adjusting the settings according to claim 4, wherein the movement of the sliding is a single point single direction sliding, a single point clockwise sliding, a single point anti-clockwise sliding, a multi-points rotating sliding, a multi-points radial sliding or a multi-points retractive sliding.

6. A method for adjusting settings of an electronic device comprising the steps of:
providing a user interface with multiple main setting menu keys and a control unit;
selecting one of the main setting menu keys to call a main setting value corresponding to the main setting menu key;
outputting a corresponding main setting option image according to the main setting value, wherein the main setting option image includes a main setting graphical user interface and a main setting value display area; and
providing a touch event to operate the control unit to adjust the main setting value;
wherein the main setting graphical user interface cooperates with the control unit to display multiple pieces of main setting value adjusting information corresponding to the control unit, and the main setting value display area displays an adjustment of the main setting value corresponding to the touch event.

7. The method for adjusting the settings according to claim 6, further comprising the steps of:
selecting a sub-setting menu key of the user interface to call and output a sub-setting graphical user interface corresponding to the sub-setting menu key, wherein the sub-setting graphical user interface displays multiple sub-setting options corresponding to the control unit; and
touching the control unit according to the sub-setting options to select one of the sub-setting options.

8. The method for adjusting the settings according to claim 7, further comprising the steps of:
calling a sub-setting value according to the selected sub-setting option;
outputting a corresponding sub-setting option image according to the sub-setting value, wherein the sub-setting option image includes a sub-setting graphical user interface and a sub-setting value display area; and
providing the touch event to operate the control unit to adjust the sub-setting value,
wherein the sub-setting graphical user interface cooperates with the control unit to display multiple pieces of sub-setting value adjusting information corresponding to the control unit, and the sub-setting value display area displays the adjustment of the sub-setting value corresponding to the touch event.

9. The method for adjusting the settings according to claim 6, wherein the touch event is achieved by pressing the control unit or clicking the control unit.

10. The method for adjusting the settings according to claim 6, wherein the electronic device is a projector, a desktop computer screen or a notebook computer screen.

11. The method for adjusting the settings according to claim 6, wherein the user interface is a touch panel or a physical keyboard.

12. The method for adjusting the settings according to claim 6, wherein the control unit is a touch scroll, a touch dial or a touch key.

13. The method for adjusting the settings according to claim 6, wherein the adjustment of setting value is shown by one or the combination a value change, an increment and decrement of a bar chart, and a contrast image before and after the adjustment.

14. An electronic device comprising:
a user interface having multiple main setting menu keys and a control unit;
a processing unit connected to the user interface and receiving a signal provided from one of the main setting menu keys to call a main setting value corresponding to the main setting menu key; and
an image output unit connected to the processing unit, wherein the processing unit drives the image output unit to output a main setting option image corresponding to the main setting value according to the main setting value, and the main setting option image at least includes a main setting value display area;
wherein the control unit receives a touch displacement event and adjusts the main setting value, the touch displacement event is achieved by moving relative to the first touch position by continuously touching the control unit after first touching the control unit, thereby adjusting the main setting value, and the main setting value display area displays the adjustment of the main setting value corresponding to the touch displacement event.

15. The electronic device according to claim 14, wherein the user interface further includes a sub-setting menu key, the processing unit receives a signal provided by the sub-setting menu key, calls and drives the image output unit to output a sub-setting menu image corresponding to the sub-setting menu key, the sub-setting menu image includes multiple sub-setting options, and the control unit receives a touch event, the processing unit drives the image output unit to display a denoting mark on the sub-setting menu image, and the control unit receives the touch displacement event to make the denoting mark move at the sub-setting options and select one of the sub-setting options corresponding to the touch displacement event.

16. The electronic device according to claim 14, wherein the processing unit calls a corresponding sub-setting value according to a selected sub-setting option and drives the image output unit to output a sub-setting option image corresponding to the sub-setting value, the sub-setting option image at least includes a sub-setting value display area, the control unit receives the touch displacement event and adjusts the sub-setting value, and the sub-setting value display area displays the adjustment of the sub-setting value corresponding to the touch displacement event.
